(19) United States
(12) Patent Application Publication
(10) Pub. No.: US 2005/0151339 A1
(43) Pub. Date: Jul. 14, 2005

(54) Torsion axle

(75) Inventor: William E. Carty, Tempe, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(73) Assignee: U-Haul International, Inc.

(21) Appl. No.: 10/754,996

(22) Filed: Jan. 10, 2004

(51) Int. Cl. B60G 11/23

(52) U.S. Cl. 280/124.169

(57) ABSTRACT

Mechanisms for preventing sway and distributing uneven forces applied on an axle in a moving vehicle are described. An axle tube is segmented into three components: two end segments and a middle segment. Spindle shafts extend from the end segments into the middle segment but do not come into direct contact with one another. Portions of the spindle shaft that are in the middle segment are press-fitted in the middle segment using inserts. The middle segment of the axle tube free to rotate. The inserts allow for interaction between both ends of the spindle shafts such that a rotational force applied to one spindle shaft is communicated to another spindle shaft. The amount of anti-sway capability desired can be calibrated by adjusting the length of the inserts and shafts in the axle tube and the materials and density of the various components.

### FIELD OF THE INVENTION

The invention relates generally to vehicle axle systems. Specifically, the present invention relates to torsion axle systems having anti-sway and load-equalizing features.

### BACKGROUND OF THE INVENTION

Various configurations of torsion axle mechanisms with compressible inserts, typically rubber, are known in the field of axle design. Torsion axles are mechanisms that reduce the sway in vehicles typically encountered when making turns in a vehicle carrying a heavy load or an unevenly distributed load. FIG. 1A is a frontal view of a known torsion axle. Shown are a continuous single tube 102 extending from end 110 to end 112. Also shown are spindle arms 108a and 108b attached to spindle 116a and 116b. Axle tube 102 is attached to a vehicle using mounting brackets 114a and 114b. FIG. 1B is a cross-sectional view of the known torsion axle design of FIG. 1A along line 1B-1B. Continuous single tube 102 having a length extending from end 110 to end 112 includes two sets of rubber inserts 104a on the left and 104b on the right, each set is comprised of four individual rubber inserts, shown more clearly in FIGS. 2A and 2B discussed below. Inserts 104a and 104b are press-fitted around pairs of spindle arm shafts 106a and 106b, respectively, all contained within continuous axle tube 102. A middle area of continuous tube 102 does not house any portion of spindle arm shafts 106a and 106b or any portion of rubber inserts 104a or 104b.

Shafts 106a and 106b are rotationally linked to spindle arms 108a and 108b, respectively. Spindle arms 108a and 108b are attached to spindle 116a and spindle 116b, respectively. Rubber inserts 104a and 104b function as suspension absorbing members, shown more clearly in FIG. 3. Left side spindle arm 108a and shaft 106a function independently from right side spindle arm 108b and shaft 106b.

FIG. 2A is a cross-sectional view of the known torsion axle design of FIG. 1A taken along line 2A-2A shown with spindle components. A spindle 116a, a spindle arm 108a, a spindle arm shaft 106a, and axle tube 102 are shown. FIG. 2B is a cross-sectional view of the torsion axle design also taken along line 2A-2A without the spindle components and with no pressure applied to the spindle. A set of inserts 104a is comprised of four individual rubber inserts 202a, 202b, 202c, and 202d press-fitted against spindle arm shaft 106a and the inside wall of axle tube 102. Each rubber insert has a generally circular cross-section when there is no pressure on spindle 116a and spindle arm 108a. FIG. 3 is a cross-sectional view of the known torsion axle taken along line 2A-2A as pressure is applied to the spindle, as shown by arrows 302. When pressure is applied to spindle 116a, spindle arm shaft 106a turns thereby applying pressure to inserts 202a, 202b, 202c, and 202d. As a result, the cross-sectional shape of the inserts becomes more oval than circular as it absorbs pressure from a load. The load may be the result of a carried payload, a vehicle maneuver or an uneven road surface.

The axle mechanism described above does not have anti-sway capability, primarily because the left and right sides of the torsion axle and the inserts are not configured in a manner that allow them to communicate forces between the left and right sides of the torsion axle. Reducing sway in a vehicle can be achieved by transferring force between separated left and right shafts of a torsion axle.

Furthermore, existing load-equalizing mechanisms between a front torsion axle and rear torsion axle have complex structures. Load-equalization is desirable in multi-stage axle mechanisms where distribution of loads between axles becomes unbalanced. It would be desirable to have a mechanism that has both anti-sway capabilities and load-equalizing features that is relatively simple in structure and design.

### SUMMARY OF THE PREFERRED EMBODIMENTS

Apparatus and methods relating to anti-sway features of a torsion axle system are described. In one aspect of the present invention, a system includes an axle assembly with two opposed ends, each end having a spindle arm, and an anti-sway mechanism disposed at a location between the two opposed ends of the axle assembly. In one embodiment the anti-sway mechanism includes an axle tube middle segment with inserts, and spindle arm shaft ends extending into the axle tube middle segment and inserts

In another aspect of the present invention an anti-sway mechanism includes an axle tube segment which houses two shafts, each shaft secured in place by inserts, typically rubber, wherein a rotational force applied to one shaft is transmitted to another shaft by the axle tube segment and the inserts. In one embodiment, the anti-sway mechanism is unattached to a vehicle frame thereby allowing the tube segment to react to a rotational force and transmit a portion of the rotational force to an opposing shaft. In another embodiment, the anti-sway mechanism includes a first set of inserts press-fitted between the axle tube segment and one of the shafts and a second set of inserts press-fitted between the axle tube segment and the other shaft, such that rotation of one shaft causes rotation of the other shaft.

In another aspect of the present invention, an axle system for a vehicle includes two end axle tube segments and a middle axle tube segment, each having inserts. One end axle tube segment contains a first portion of a first spindle shaft attached to a first spindle arm. Another end axle tube segment contains a first portion of a second spindle shaft attached to a second spindle arm. The middle axle tube segment contains a second portion of the first spindle shaft and a second portion of the second spindle shaft, wherein the middle axle tube segment is separate from the two end axle tube segments.

In another aspect of the present invention, a method of adjusting anti-sway capability of an axle is described. A length of a first set of inserts in a middle segment of an axle tube is adjusted to be shorter or longer. A length of a second set of inserts in the middle segment of the axle tube may also be adjusted to be shorter or longer. In one embodiment, the length of a third set of inserts in at least one of two end segments of the axle tube is adjusted. In yet another embodiment, one or more of the compressibility, density, resilience and material of the inserts are adjusted to achieve the desired anti-sway capability of the torsion axle.

In another aspect of the present invention, an anti-sway mechanism of an axle system is described. The anti-sway mechanism includes an end portion of a spindle shaft extending into a center axle tube and pressure-absorbing inserts positioned between an outer surface of the end portion of the spindle shaft and an inner surface of the center axle tube. An outside portion of the spindle arm shaft is connected to a spindle arm such that when pressure is applied to the spindle arm, the pressure is transferred through the end portion of the spindle shaft to the pressure-absorbing inserts in the center axle tube.

In another aspect of the present invention, an anti-sway mechanism is described. The anti-sway mechanism has a spindle shaft having an outer surface contained in an axle tube segment having an inner surface and a first set of inserts housed between the inner surface of the axle tube segment and the outer surface of the spindle shaft. The anti-sway mechanism also includes another spindle shaft having an outer surface contained in the axle tube segment and another set of inserts housed between the inner surface of the axle tube segment and the outer surface of the spindle shaft, wherein the axle tube segment can rotate such that a portion of a force causing rotation of one spindle shaft is transferred to the other spindle shaft. This transfer occurs through the axle tube segment and the sets of inserts.

### BRIEF DESCRIPTION OF THE DRAWINGS

FIG. 1A is a frontal view of a known torsion axle.

FIG. 1B is a cross-sectional view of the known torsion axle design of FIG. 1A taken along line 1B-1B.

FIG. 2A is a cross-sectional view of the known torsion axle design of FIG. 1A taken along line 2A-2A.

FIG. 2B is a cross-sectional view of the known torsion axle design of FIG. 1A taken along line 2B-2B and shown with spindle components.

FIG. 3 is a cross-sectional view of the known torsion axle design of FIG. 1A taken along line 2B-2B as pressure is applied to a spindle.

FIG. 4A is a frontal view of a torsion axle system in accordance with one embodiment of the present invention.

FIG. 4B is a cross-sectional view of the torsion axle system of FIG. 4A taken along line 4B-4B.

FIG. 5A is a cross-sectional view of the torsion axle system of FIG. 4A taken along line 5A-5A.

FIG. 5B is a cross-sectional view of the torsion axle system of FIG. 4A taken along line 5A-5A as pressure is applied to a spindle.

FIG. 6 is a cross-sectional view of a portion of the torsion axle system of FIG. 4A taken along line 6-6.

FIG. 7 is a cross-sectional view of the torsion axle system of FIG. 4A taken along line 4B-4B without the spindle components.

FIG. 8A is a cross-sectional view of two torsion axle systems of FIG. 4A taken along line 4B-4B with mounting brackets and an axle equalizing link between axle tube middle segments in accordance with one embodiment of the present invention.

FIG. 8B is a cross-sectional view of two torsion axle systems of FIG. 4A taken along line 4B-4B of each axle with mounting brackets and two axle equalizing links between axle tube end segments in accordance with one embodiment of the present invention.

FIG. 9 is a cross-sectional view of two torsion axle systems of FIG. 4A taken along line 5A-5A including arrows showing forces exerted when equalizer link equalizes forces between axles in accordance with one embodiment of the present invention.

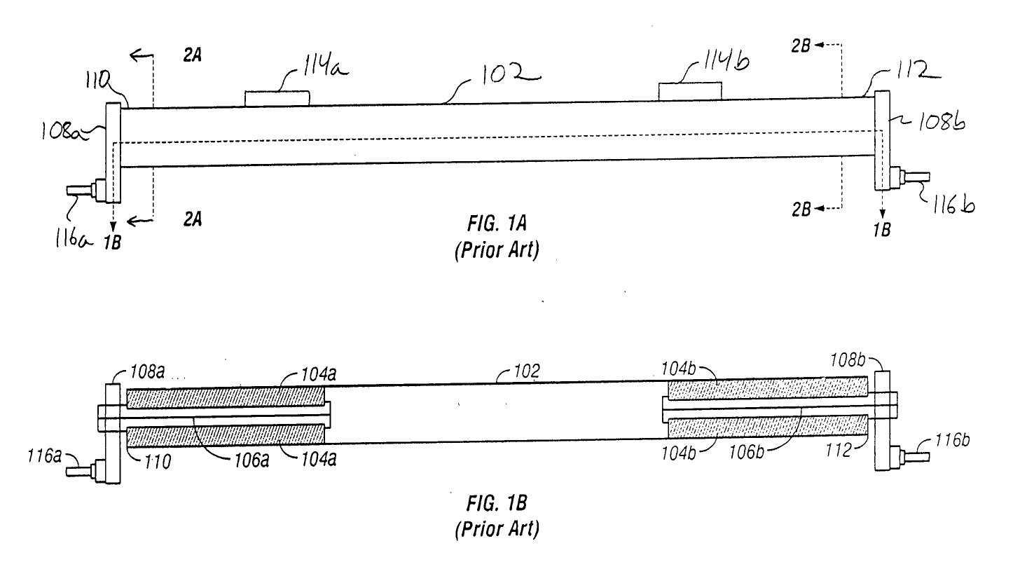

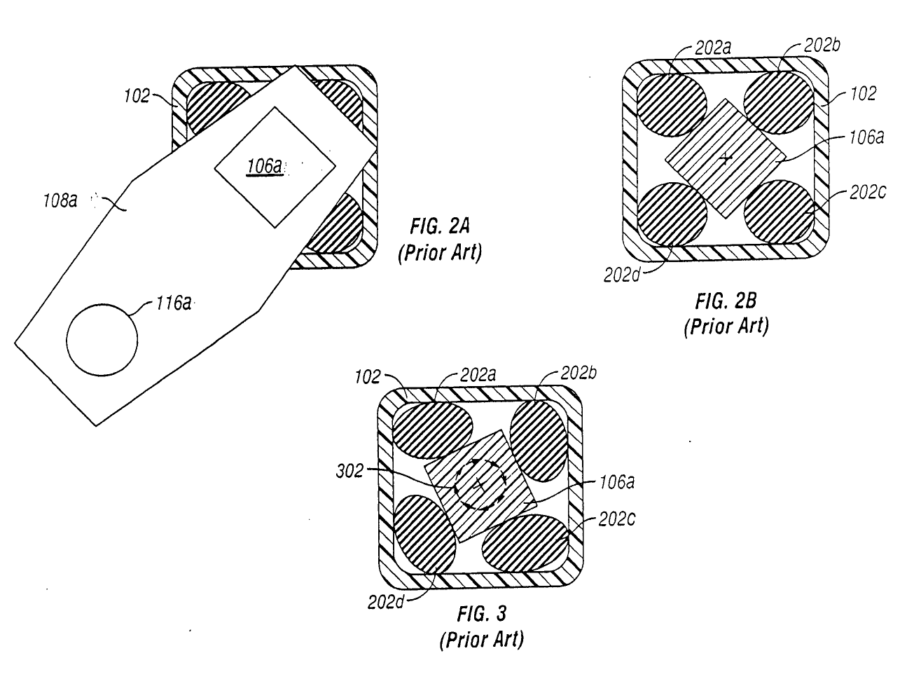

### DESCRIPTION OF THE PREFERRED EMBODIMENTS

A torsion axle system having anti-sway capabilities is described in the various figures. The system utilizes a segmented axle tube for housing extended spindle shafts and pressure-absorbing inserts, collectively providing anti-sway capability for a vehicle.

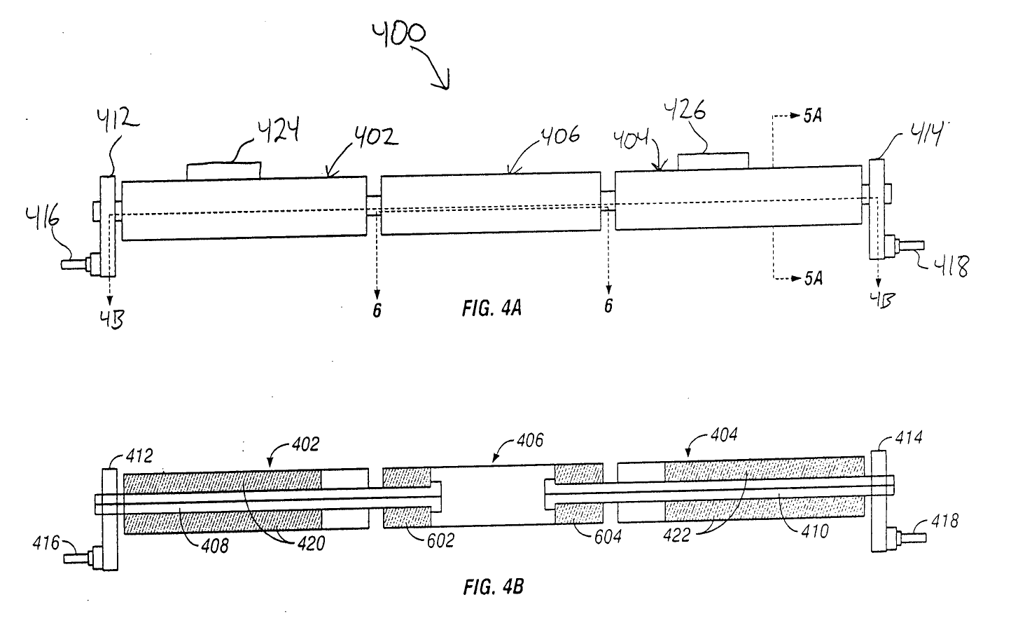

FIG. 4A shows a torsion axle system in accordance with one embodiment of the present invention. An axle tube 400 is comprised of three non-continuous segments: two end segments 402 and 404 and a middle segment 406. Also shown are spindle arms 412 and 414 and spindles 416 and 418. Tube segments 402 and 404 are mounted to brackets 424 and 426, respectively, which are attached to a vehicle frame (not shown). In a preferred embodiment middle segment 406 is separate from tube segments 402 and 404 in that the two end segments of the axle tube are not connected to the middle segment. In a preferred embodiment, middle segment 406 is disposed at the center of axle tube 400 as shown in FIG. 4. However, in other embodiments, middle segment 406 can be disposed closer to one end of axle tube 400 than to the other.

FIG. 4B shows a cross-section of axle tube 400 taken along line 4B-4B. Two spindle arm shafts 408 and 410 extend from one side of axle tube end segments 402 and 404 to within the interior of axle tube middle segment 406. The ends of shafts 408 and 410 in middle segment 406 widen to secure their positions. Spindle arm shafts 408 and 410 extend beyond tube segments 402 and 404 into tube segment 406.

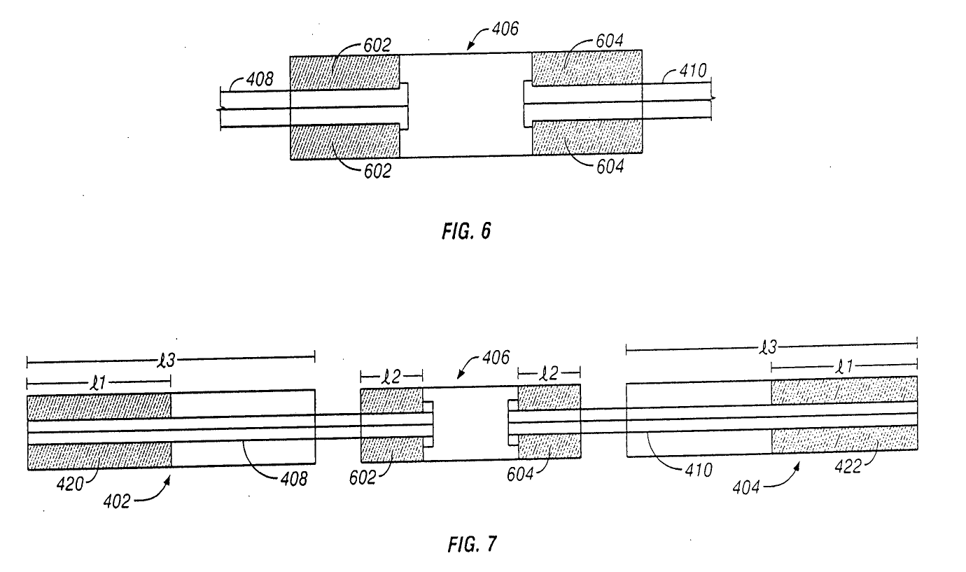

Spindle arm shaft 408 is attached to spindle arm 412 and spindle arm shaft 410 is attached to spindle arm 414, such that rotational movement of a spindle arm causes rotational movement of the spindle arm shaft. Spindle arms 412 and 414 are linked to spindles 416 and 418, respectively. In a preferred embodiment, a set of inserts 420 and 422 are press-fitted into axle tube end segments 402 and 404. In a preferred embodiment, a set of inserts includes four inserts. In other embodiments, there may be fewer or more inserts in axle tube end segments 402 and 404. For example, there can be three or two inserts in an axle tube depending on the cross-sectional shape of the tube and the spindle arm shaft. Inserts 420 and 422 are typically shorter in length than the length of axle tube segments 402 and 404. However, in another embodiment, they may be the same length as axle tube segments 402 and 404. Also shown are inserts 602 and 604 in middle axle tube segment 406, discussed below with reference to FIG. 6.

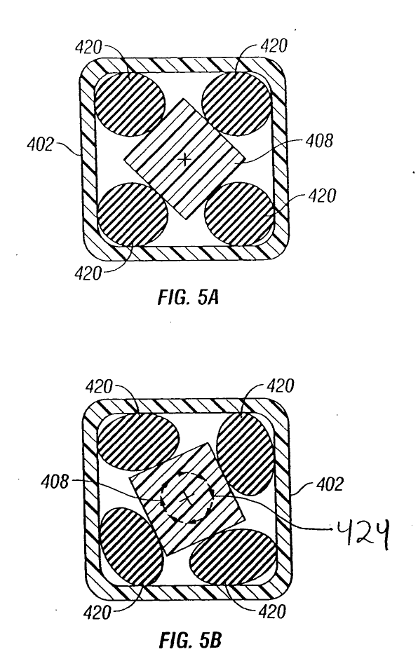

FIG. 5A shows a cross-sectional view of axle tube 400 taken along line 5A-5A. Shown are rubber inserts 420 press-fitted in tube segment 402 against spindle arm shaft 408. FIG. 5B shows the same cross-sectional view of axle tube 400 when a load is applied to the spindle. When a load is applied, shown by arrows 424, the spindle arm shaft turns which causes the spindle arm shaft to turn thereby applying pressure to the rubber inserts. The cross-sectional shapes of the inserts become more oval than circular as they absorb pressure from the load. In other preferred embodiments, the cross-sectional shape of the inserts can be other shapes; for example, circular, so they cannot rotate out of place, half-circular, or the insert material can fill the entire space around shaft 408 and axle tube 400. However, it should be understood that the inserts are not shape limited. In a preferred embodiment, the inserts are made from rubber. In other embodiments, other types of resilient and compressible materials can be used. In a preferred embodiment, the inserts allow the spindle arm shafts to rotate to some degree, most generally between 0° to 45°.

Spindle arm shafts 408 and 410 extend into axle tube middle segment 406. FIG. 6 shows a cross-sectional view axle tube 400 middle segment 406 taken along line 6-6. In a preferred embodiment, inserts 602 and 604 are press-fitted between axle tube segment 406 and spindle arm shafts 408 and 410, respectively. As shown in FIG. 4 and FIG. 6, in a preferred embodiment, the extended spindle arm shafts are not physically locked together or do they have any direct contact with each other.

However, middle tube segment 406 and inserts 602 and 604 enable an interaction or communication between opposed spindle arm shafts 408 and 410. The two shafts are reactive to each other in that when a rotational force is applied to one shaft, this force is communicated to the other shaft through rubber inserts 602 and 604 and the rotational movement of middle tube segment 406. The rotational force applied to one shaft results in the transmission of forces received by the other shaft through the rotational movement of axle tube middle segment 406. The rotational movement of a spindle arm shaft causes middle segment 406 to rotate. The rotation of middle segment 406 transmits rotational forces to the other spindle arm shaft via inserts 602 and 604. The rotational movement of middle segment 406 is possible because segment 406 is not mounted to the vehicle frame or any other object and is free to rotate in either direction (unlike end axle tube segments 402 and 404). As described below, this interaction or communication is predictable and can be calibrated to produce effective anti-sway capability.

In other preferred embodiments, materials other than rubber, such as springs, can be used for transmitting forces through axle tube middle segment 406 and in end tube segments 402 and 404. If springs are used, an outer end of a spring is fixedly attached to a component, such as a spindle arm, and the inner end of the spring comes in contact with and rotates middle segment 406 when forces are exerted on the spindle. By rotating segment 406, forces are transmitted to a second spring on the other side of axle tube 400. In this embodiment, two springs, one at each end of the axle tube, fit around a circular axle tube.

In a preferred embodiment, the degree of anti-sway capability of a given torsion axle can be adjusted in numerous ways. One is by changing the length of inserts 602 and 604 in axle tube middle segment 406. FIG. 7 shows a cross-sectional view of axle tube 400 taken along line 4B-4B without the spindle components. The figure shows many of the components shown in previously described figures: axle tube end segments 402 and 404 and middle segment 406, end segment rubber inserts 420 and 422, middle segment rubber inserts 602 and 604, and spindle shafts 408 and 410. In addition, FIG. 7 shows various lengths of some of these components. Shown are various component lengths /, including, /1, the length of end segment rubber inserts 420 and 422; /2, the length of middle segment rubber inserts 602 or 604; and /3, the length of axle tube end segments 402 or 404. Length /3 can also be defined as the distance from one end of the axle to the first disjoint of the axle tube.

One way of calibrating the anti-sway capability of a torsion axle is by adjusting length /2 of middle segment rubber inserts 602 and 604. If stronger anti-sway functionality is desired; length /2 can be made longer. If less anti-sway functionality is desired, length /2 can be made shorter. In another embodiment, length /2 can be held constant while changing the material used for the inserts. In other embodiments, the length and material of the inserts can be modified. Similarly, the anti-sway capability of the torsion axle can be calibrated by adjusting length /1 of end segment rubber inserts 420 and 422.

In another embodiment, anti-sway capability of the torsion axle can be calibrated by adjusting length /3, the length of the tube end segments and the length of inserts 420 and 422. That is, by adjusting the location of the disjoints in the axle tube, the anti-sway capability of the axle can be tuned. As with the anti-sway feature of middle segment 406, changing the type of material of inserts 420 and 422 can also adjust the anti-sway capability of the axle. In other preferred embodiments, the length and material of the spindle shafts and various dimensions of the components described above can be adjusted to calibrate the anti-sway capability of the torsion axle. In other preferred embodiments, the durometer of the inserts can be changed. Changing the durometer includes adjusting the resilience, compressibility, and density of the insert material to calibrate the anti-sway capability of the torsion axle. In another embodiment in which springs are used to absorb pressure, the tension and torsional properties of the springs can be adjusted to calibrate the anti-sway capability of the torsion axle.

A multi-axle vehicle having anti-sway features of the present invention can operate in conjunction with a multi-axle equalizing mechanism. A multi-axle equalizing mechanism allows a vehicle load to be balanced between two torsion axles that have the same load rating. An axle load rating is a recommended working load (e.g., 2000 lbs, 3500 lbs.) for a particular axle. This load recommendation is generally based on weights an axle can carry. It is normally desirable that each axle carry similar load amounts. If a particular axle temporarily experiences a heavier load, for example when the vehicle hits a bump, it is desirable to contemporaneously equalize the temporary unevenness of load between two axles. In another scenario, the differential in axle load may be continual (e.g., a moving van carrying a heavier load on one end of the van) in which case multi-axle equalizing should be constant.

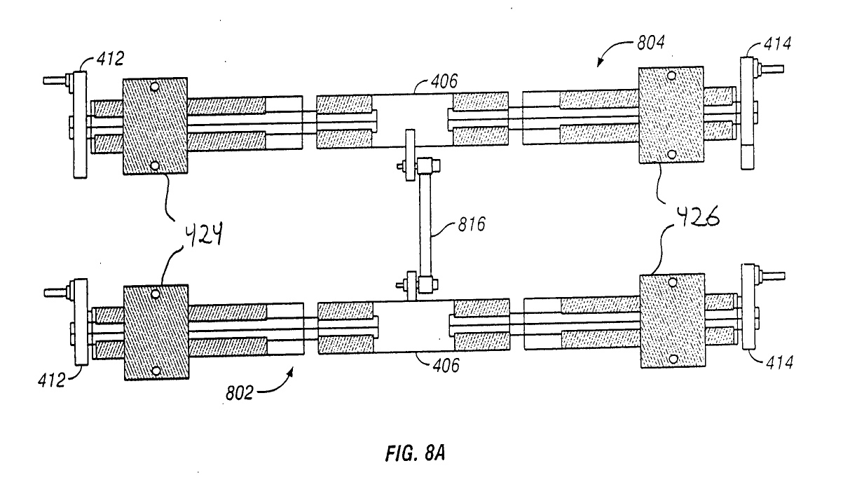

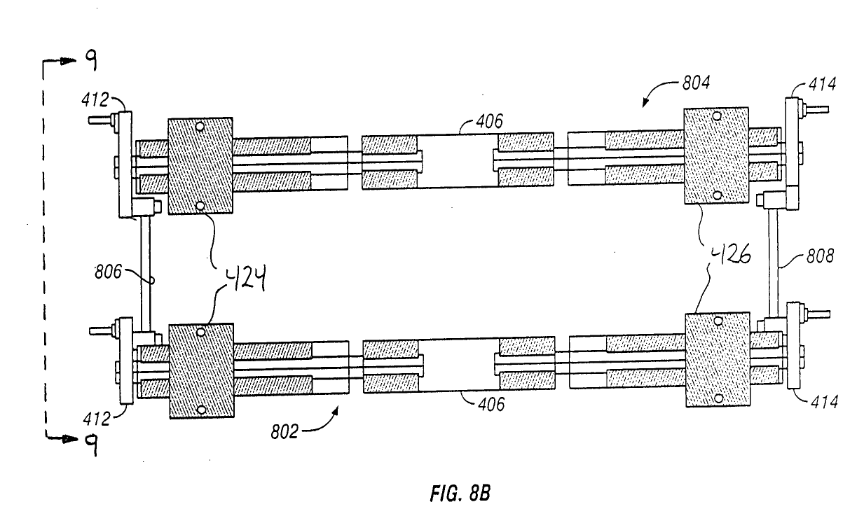

Multi-axle load equalizing can be achieved by having one or more links, also referred to as struts, between axles. FIG. 8A is a cross-sectional top view of two torsion axles with anti-sway components and an axle equalizing link taken along line 4B-4B with respect to each axle. A link 816 connects a front torsion axle 802 and a rear torsion axle 804 at axle tube middle segments 406. FIG. 8B is a cross-sectional top view similar to FIG. 8A of two torsion axles with axle equalizing links in accordance with one embodiment of the present invention. A front torsion axle 802 is linked to a rear torsion axle 804 by equalizer links 806 and 808. Links 806 and 808 are attached to the distal portions of spindle arms 412 and 414. Also shown are mounting brackets 424 and 426. Links 806 and 808 or link 816 equalize the load between axles 802 and 804.

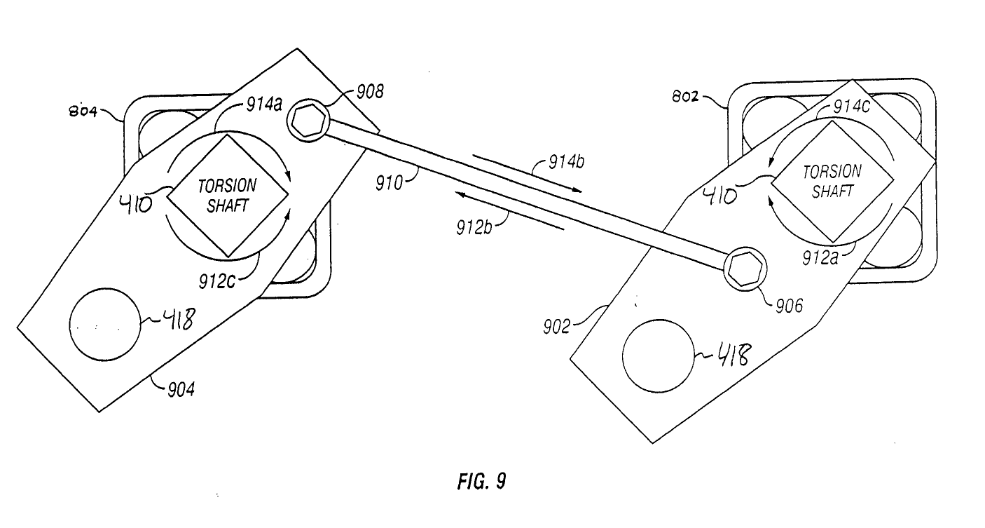

FIG. 9 shows a cross-sectional view of two torsion axle systems shown in FIG. 8B taken along line 9-9 including arrows showing forces exerted when equalizer link equalizes forces between axles. Front axle 802 having a spindle arm 902 is connected to rear axle 804 having a spindle arm 904. Spindle arm 902 is connected to an equalizer link anchor bracket 906 and spindle arm 904 is connected to an equalizer link anchor bracket 908. In the configuration shown, spindle arms 902 and 904 are positioned rearward of the axles. In other embodiments, the spindle arms can be positioned in front of the axle tubes. Anchor brackets 906 and 908 connect to an equalizer link 910. Equalizer link 910 can be made of steel or any material sufficiently strong to withstand tensile and compressive loads between spindle arms 902 and 904 so that link 910 will not bend. In another preferred embodiment, equalizer link 910 is connected to middle tube segment 406 instead of spindle arms as shown in FIG. 8A. In another embodiment, two equalizer links connect middle tube segments 406.

In a preferred embodiment, anchor bracket 906 on front axle spindle arm 902 is between the torsion shaft and the spindle and anchor bracket 908 is adjacent to the torsion shaft opposite the spindle. The distance between anchor bracket 906 and torsion shaft may be the same as or different from the distance between anchor bracket 908 and the torsion shaft on the rear spindle arm. In another embodiment, the anchor brackets may be separate from spindle arms 904 and 902.

FIG. 9 has arrows to show forces exerted when equalizer link 910 attempts to equalize forces between axles. For example, when an uneven load or force is applied to front axle 802, front spindle arm 902 rotates clockwise and upward as shown by arrow 912a. By rotating clockwise and upward, equalizer link 910 is driven away from the front axle as shown by arrow 912b. This force, in turn, drives rear spindle arm 904 downward or counterclockwise as shown by arrow 912c. By driving the rear spindle arm 904 downward, the front axle is relieved of a portion of the excessive force that was applied to it. Similarly, when an excessive force or load is applied to the rear torsion axle 804, rear spindle arm 904 rotates upward or clockwise as indicated by arrow 914a. This excess force causes equalizer link 910 to move forward as shown by arrow 914b. The excess force is equalized when front spindle arm 902 rotates downward or counterclockwise as shown by arrow 914c. In both cases, equalizing link 910 strives to equalize uneven forces between the two axles by transmitting forces from one axle to another

The embodiments of the present invention recited herein are intended to be merely exemplary and those skilled in the art will be able to make numerous modifications to them without departing from the spirit of the present invention. For example, the cross-sectional shape of the inserts can have shapes other than circular. In another example, springs, rather than inserts, can be used to absorb pressure from a load. In another example, the anti-sway mechanism can be closer to one side of the axle tube rather than being generally in the center. All such modifications are intended to be within the scope of the present invention as defined by the claims.

1. A suspension system comprising:
an axle assembly having opposed ends, each end having a spindle arm; and
an anti-sway mechanism disposed at a location between each spindle arm.

2. A suspension system as recited in claim 1 wherein the anti-sway mechanism comprises:
an axle tube segment; and
opposed spindle arm shaft ends disposed within the axle tube segment.

3. A suspension system as recited in claim 2 wherein the anti-sway mechanism further comprises:
a plurality of inserts spaced between the spindle arm shaft ends and the axle tube segment.

4. A suspension system as recited in claim 3 wherein the inserts are rubber.

5. A suspension system as recited in claim 4 wherein the inserts are press fitted.

6. A suspension system as recited in claim 1 wherein the anti-sway mechanism is unattached to a vehicle frame.

7. An anti-sway mechanism comprising:
an axle tube segment containing a first shaft and a second shaft, each shaft secured by a plurality of inserts, wherein a rotational force applied to a first shaft is transmitted to the second shaft by the axle tube segment and the plurality of inserts.

8. An anti-sway mechanism as recited in claim 7 wherein the axle tube segment is unattached to a vehicle frame thereby allowing the tube segment to react to the rotational force and transmit a portion of the rotational force to the second shaft.

9. An anti-sway mechanism as recited in claim 8 wherein a first subset of the plurality of inserts are press-fitted between the axle tube segment and the first shaft and a second subset of the plurality of inserts are press-fitted between the axle tube segment and the second shaft such that rotation of the first shaft causes rotation of the second shaft.

10. An axle system for a vehicle comprising:
a first axle tube segment containing a first portion of a first spindle shaft attached to a first spindle arm;
a second axle tube segment containing a first portion of a second spindle shaft attached to a second spindle arm; and
a third axle tube segment containing a second portion of the first spindle shaft and a second portion of the second spindle shaft, wherein the third axle tube segment is separate from the first and second axle tube segments.

11. An axle system as recited in claim 10 wherein the first axle tube segment is attached to a first bracket which is attached to a vehicle frame.

12. An axle system as recited in claim 10 wherein the second axle tube segment is attached to a second bracket which is attached to a vehicle frame.

13. An axle system as recited in claim 10 further comprising:
a first plurality of pressure absorbing inserts disposed in the first axle tube segment, wherein at least one insert is wedged between an inner surface of the first axle tube segment and an outer surface of the first spindle shaft; and
a second plurality of pressure absorbing inserts disposed in the second axle tube segment, wherein at least one insert is wedged between an inner surface of the second axle tube segment and an outer surface of the second spindle shaft.

14. An axle system as recited in claim 10 further comprising:
a third plurality of pressure absorbing inserts disposed in the third axle tube segment.

15. An axle system as recited in claim 14 wherein the third plurality of pressure absorbing inserts further comprises:
a fourth plurality of pressure absorbing inserts, wherein at least one insert is wedged between an inner surface of the third axle tube segment and an outer surface of the second portion of the first spindle shaft; and
a fifth plurality of pressure absorbing inserts, wherein at least one insert is wedged between an inner surface of the third axle tube segment and an outer surface of the second portion of the second spindle shaft.

16. An axle system as recited in claim 10 wherein a first torsion spring is disposed around the first axle tube segment and a second torsion spring is disposed around the second axle tube segment.

17. An axle system as recited in claim 10 wherein a third portion of the first spindle shaft is not covered by one of the first axle tube segment, the second axle tube segment, and the third axle tube segment.

18. An axle system as recited in claim 10 wherein a third portion of the second spindle shaft is not covered by one of the first axle tube segment, the second axle tube segment, and the third axle tube segment.

19. An axle system as recited in claim 13 wherein the pressure absorption inserts are rubber.

20. An axle system as recited in claim 10 wherein the third axle tube segment is unattached to the vehicle frame.

21. A method of adjusting anti-sway capability of an axle comprising:
adjusting a first length of a first plurality of inserts in a middle segment of an axle tube; and
adjusting a second length of a second plurality of inserts in the middle segment of the axle tube.

22. A method as recited in claim 21 wherein the first length and the second length are made the same length.

23. A method as recited in claim 21 further comprising:
adjusting a third length of a third plurality of inserts in a first end segment of the axle tube.

24. A method as recited in claim 23 further comprising:
adjusting a first end segment length and a third shaft length.

25. A method as recited in claim 24 further comprising:
adjusting a second end segment length and a fourth shaft length.

26. A method as recited in claim 21 further comprising:
adjusting a fourth length of a fourth plurality of inserts in a second end segment of the axle tube.

27. A method as recited in claim 21 further comprising:
adjusting a first shaft length and a second shaft length, the first shaft length and the second shaft length disposed in the middle segment of the axle tube.

28. A method as recited in claim 21 further comprising adjusting a middle segment length.

29. A method of adjusting anti-sway capability of an axle comprising changing the durometer of an insert in a plurality of inserts in a middle segment of an axle tube.

30. A method as recited in claim 29 wherein changing the durometer further comprises changing one or more of the resilience, density, and compressibility of an insert.

31. An anti-sway mechanism of an axle system comprising:
an end portion of a spindle shaft extending into a center axle tube, pressure-absorption inserts positioned between an outer surface of the end portion of the spindle shaft and an inner surface of the center axle tube; and
an outside portion of the spindle arm shaft connected to a spindle arm, such that when pressure is applied to the spindle arm, the pressure is transferred through the end portion of the spindle shaft to the pressure-absorption inserts in the center axle tube, wherein the center axle tube is able to rotate when pressure is transferred from the end portion of the spindle shaft to the pressure-absorption inserts in the center axle tube, wherein the pressure is further transferred from the pressure-absorption inserts to an opposed spindle shaft, and wherein the opposed spindle shaft extends into the center axle tube.

32. An anti-sway mechanism as recited in claim 31 wherein the anti-sway mechanism is a single integrated assembly.

33. An anti-sway mechanism as recited in claim 31, further comprising a load equalizing multi-axle system including at least one link, wherein two rotationally load reactive middle segments are connected by a link allowing pressure from a load on a first axle to be transferred to a second axle.
